(19) United States
(12) Patent Application Publication
(10) Pub. No.: US 2012/0049567 A1
(43) Pub. Date: Mar. 1, 2012

(54) LOAD CARRYING TRUCK BED BOX TONNEAU COVER

(76) Inventor: Jay Anton Spanjers, Brooklyn Park, MN (US)

(21) Appl. No.: 13/217,237

(22) Filed: Aug. 24, 2011

Related U.S. Application Data
(60) Provisional application No. 61/376,678, filed on Aug. 25, 2010.

(51) Int. Cl. B60P 7/02

(52) U.S. Cl. 296/100.06

(57) ABSTRACT

The load carrying truck bed tonneau cover described herein and depicted in the included figures may be secured to the bedrails of a pick-up truck, or the chassis of a truck, and includes an easily installed cargo deck frame assembly that is affixed to the upper portion of the bed rails of the truck bed box for supporting a cargo deck assembly engaged with the cargo deck frame assembly by means of a cam assembly of a plurality of movable cams to provide a generally rigid tonneau cover and a selected locking assembly.

### CROSS-REFERENCE TO RELATED APPLICATIONS

This application claims the benefit of Provisional Application Ser. No. 61/376,678, Filed On 25 Aug. Mar. 2010, which is hereby incorporated by reference herein in its entirety; and also claims the benefit of Provisional Application Ser. No. 61/316,786, Filed On 23 Mar. 2010, now U.S. patent application, Ser. No. 13/069,382 Filed on 23 Mar. 2011, which is hereby incorporated by reference herein in its entirety.

### FIELD OF INVENTION

This invention relates to truck accessories, accessories for a trailer and more particularly to cargo systems for interfacing with the chassis of a truck or trailer, and more particularly the truck bed body box. More specifically, the present invention is directed to load carrying tonneau cover, and a kit of components for providing a load carrying tonneau cover that is easily installed and uninstalled.

### BACKGROUND

Since the introduction of the pickup truck with its open bed, tailgate and sidewalls there has been myriad products produced to take advantage of the cargo carrying capability. These products range from full size camping toppers complete with installed appliances to tool boxes for construction crews, to gas tanks that can be used to fill tractors and construction machinery, and ladder racks of all shapes and sizes. Another accessory that has many variants is the bed cover that protects the contents of the bed from the elements. These range from the sheet metal “topper” that extends the full length of the pick-up bed horizontally and vertically that are approximately or slightly higher than the top of the cab, to covers that are fabricated from sheet metal or cloth that are flush with the top of the bed. All these products have merit for a limited range of applications, but are not specifically designed carrying a load, for example, an ATV, snowmobile, or other heavy equipment or materials.

### BRIEF DESCRIPTION OF THE INVENTION

The load carrying truck bed tonneau cover described herein and depicted in the included figures may be secured to the bedrails of a pick-up truck, or the chassis of a truck, and includes an easily installed cargo deck frame assembly that is affixed to the upper portion of the bed rails of the truck bed box for supporting a cargo deck assembly engaged with the cargo deck frame assembly by means of an cam assembly of a plurality of movable cams to provide a generally rigid tonneau cover and a selected locking assembly.

Further, in accordance with the present invention, the cargo deck includes longitudinal gaskets for laying on top of upper portions of the truck box side walls, and forward and rearward gaskets for generally preventing water from entering the cargo storage below the cargo deck, the gaskets being, for example, pliable EPDM.

Further, in accordance with the present invention, the cargo deck includes at least one door extending the length of the truck bed, and includes a water shedding hinge, being, for example, pliable EPDM.

Further, in accordance with one embodiment of the present invention, the load carrying truck bed tonneau cover is provided by a kit of cooperating components comprising: i) a pair of C-channel like members and clamps for being mountable to internal sides of the truck bed body box; ii) a first pair of struts, preferably telescoping, for engagement with side C-channels; iii) a cargo deck including a first substrate with longitudinal door substrates hingeably secured to the sides of the first substrate, and including surrounding gaskets for engagement with the upper portions of the truck body box side walls that forms the truck bed—sides and forward portion, and the tail gate; a slideably engageable cam assembly mounted to each longitudinal door truck bed facing surface for subsequent engagement with each side C-channel; a forward telescoping strut for engagement with the C-channel at the forward end of the truck bed box that is preferably mounted to the truck facing surface of the first substrate of the cargo deck, and a rearward telescoping strut for engagement with the C-channel at the rearward end of the truck bed that may be mounted to the truck facing surface of the first substrate; and iv) a plurality of cotter-less pins, clevis pins, or the like for quick assembly and removal of the tonneau cover with a minimum of any tools.

Further components may include a pair of gas struts for upward tilting of the cover deck. The deck cover may be provided by a wide array of materials that may be paintable to match the truck, and waterproof for lasting wear. One example is a urethane coating similar to common truck bed liners.

As used herein, the aforementioned C-channel member refers to any structure beyond just the C-channel, and may be provided by a variety of extrusions for serving the intended purpose of both an inward facing C-channel and lip or flange for making contact with the upper portion of the truck box side walls and cover assembly gaskets.

Use of telescoping struts in accordance with the present invention permits the tonneau cover to be incorporated in a lowered portion of the truck box by applying the struts to the lowered indentations or pockets of the truck side walls in proximity to the wheel wells. Further, in this application forward and rearward struts may include legs for corners of the truck bed and the hinge space of the tailgate.

### DESCRIPTION OF THE DRAWINGS

FIG. 1 is a perspective view of a truck box and load carrying truck bed tonneau cover kit showing (i) the deck cover assembly lying on the truck bed including doors and cam assembly, and forward and rearward struts mounted to the underside of the deck cover substrate, and a plurality of telescoping struts, and (ii) the cargo deck frame assembly including the C-channel members secured the upper portion of the side truck box side walls by a plurality of clamps, and (iii) a pair of gas rearward gas struts in accordance with the present invention.

FIG. 2 is another perspective view of load carrying truck bed tonneau cover where the deck cover assembly is resting on the cargo deck frame assembly with doors open, and shows the cotter-less pins engaged into the telescoping struts, and the compression fitting knob that secures the slideably engaging member of the telescoping rearward strut secured within and engaged with the c-channel; and also shows the c-channel member to include a flange for lying on the upper portion of the truck box sides.

FIG. 3A-B illustrates a perspective view of the rearward telescoping strut both away from and engaged with the C-channel member. Also shown is the arrangement of the gas strut secured to a structural member of a next telescoping strut held in position by a cotter less pin.

FIG. 4 shows a perspective of the deck cover assembly leaning on a secured strut engaged with the deck before being lifted onto the remaining struts of the cargo deck frame assembly.

FIG. 5A-B illustrates the gasket being lifted away from the tail gate before the tail gate is closed, and then after the tail gate is closed demonstrating how the entire tonneau cover may be transported on the truck bed.

FIG. 6 illustrates an exemplary mounting of the gas strut to a structural member of one of the telescoping struts.

FIG. 7 shows a door prop mounted to the forward strut of the deck cover assembly for maintaining the door open as desired

### EXEMPLARY METHOD OF TONNEAU COVER

The following is an exemplary method of removal of the load carrying tonneau cover of the present invention. In the following, the 1st and 5th struts are mounted to the deck cover assembly at forward (near cab) and the rearward (tail gate) positions.

### Removing the MuleBack Deluxe Model with Five Struts from Truck

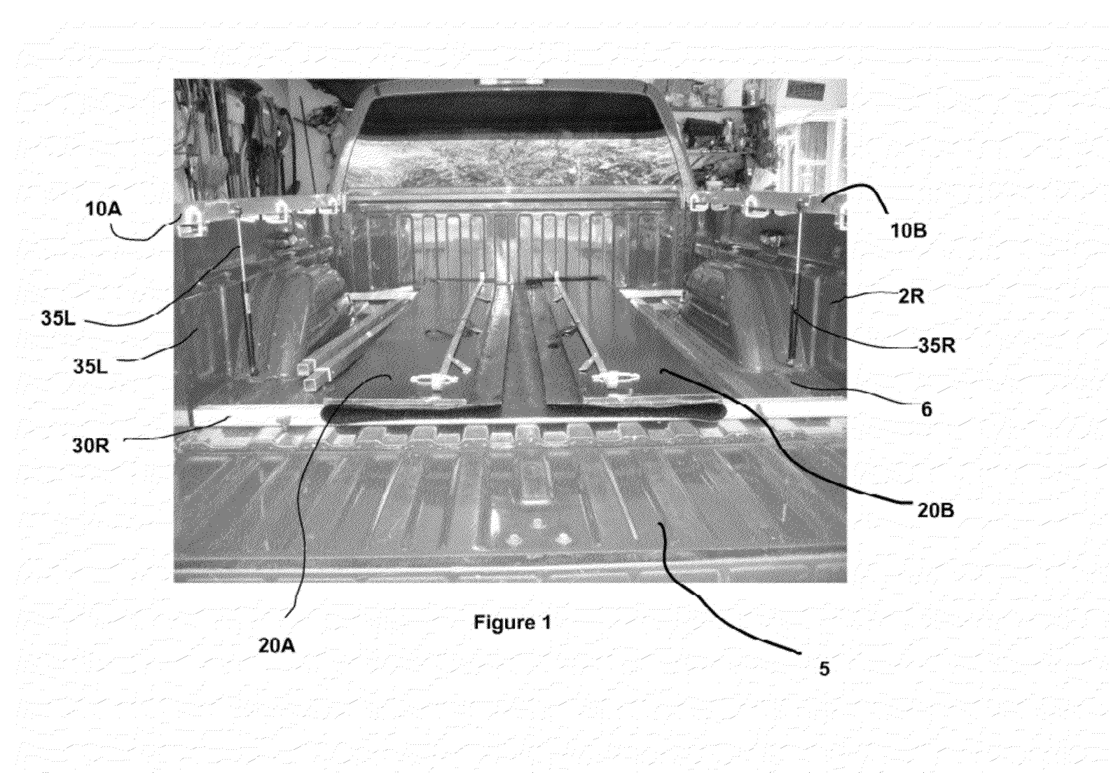

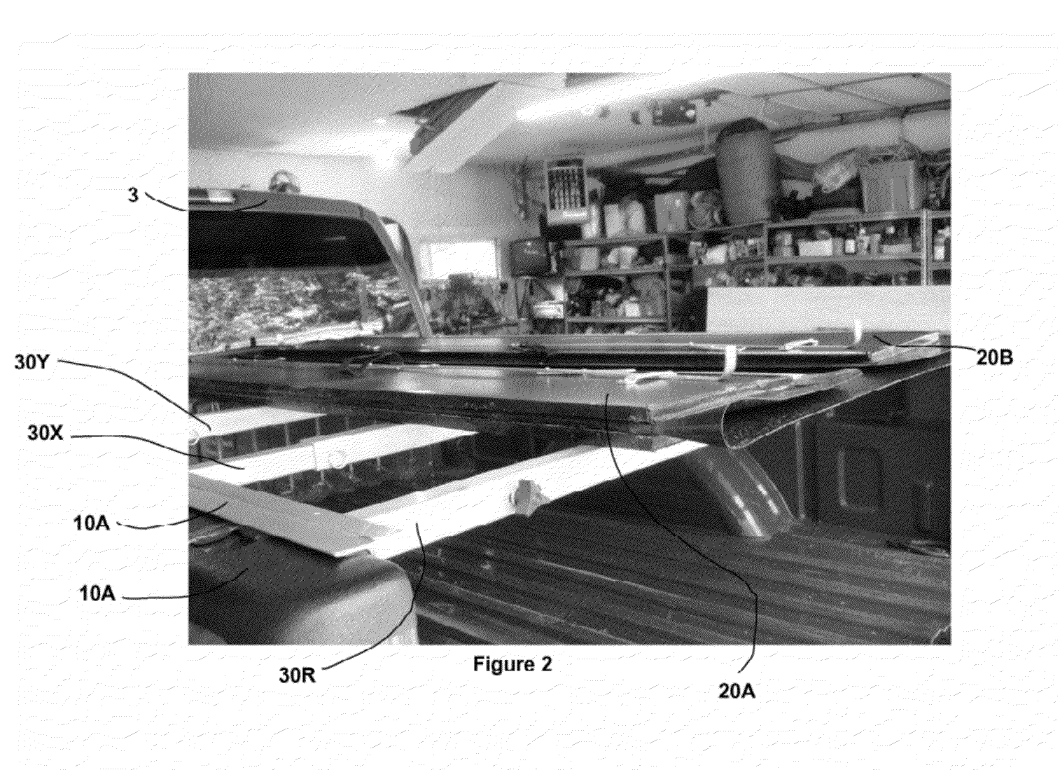

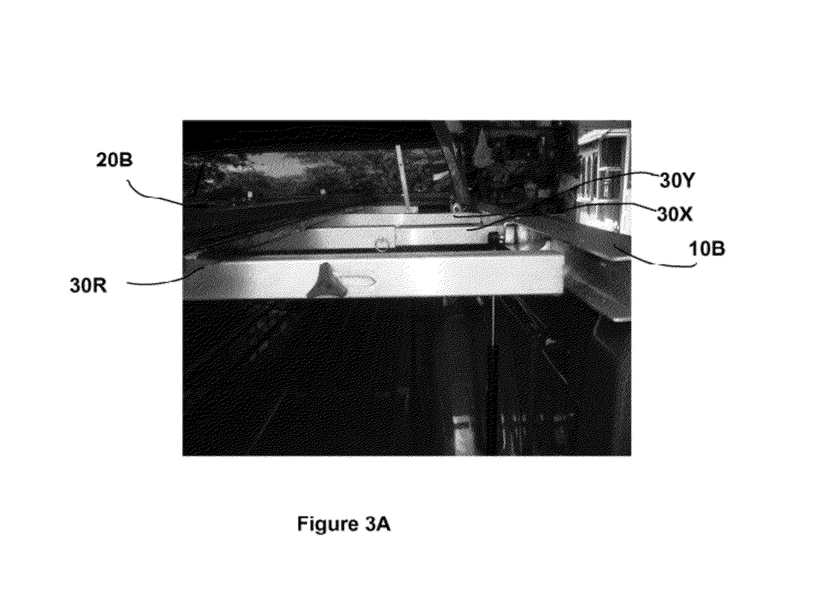

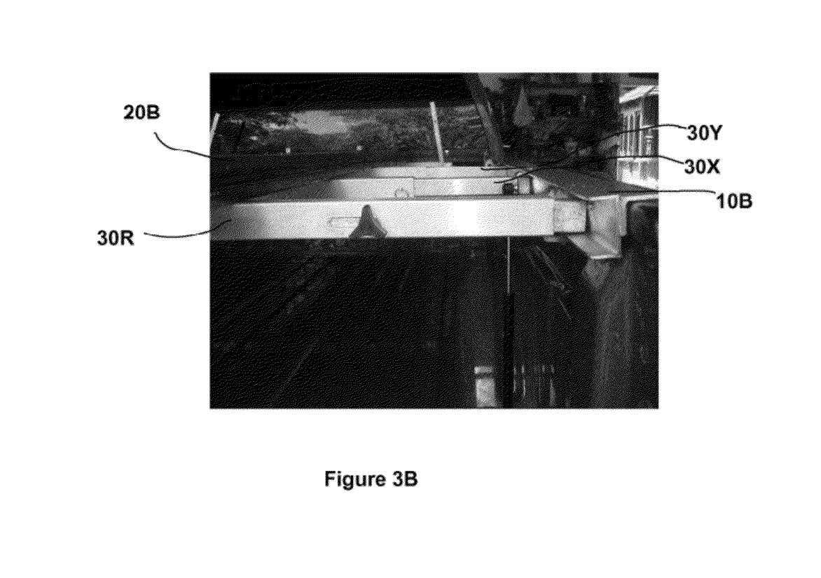

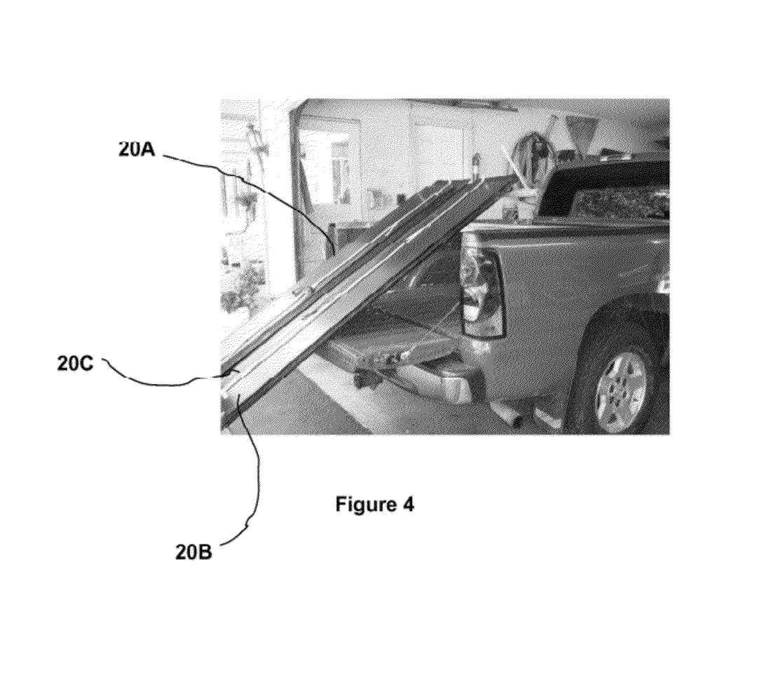

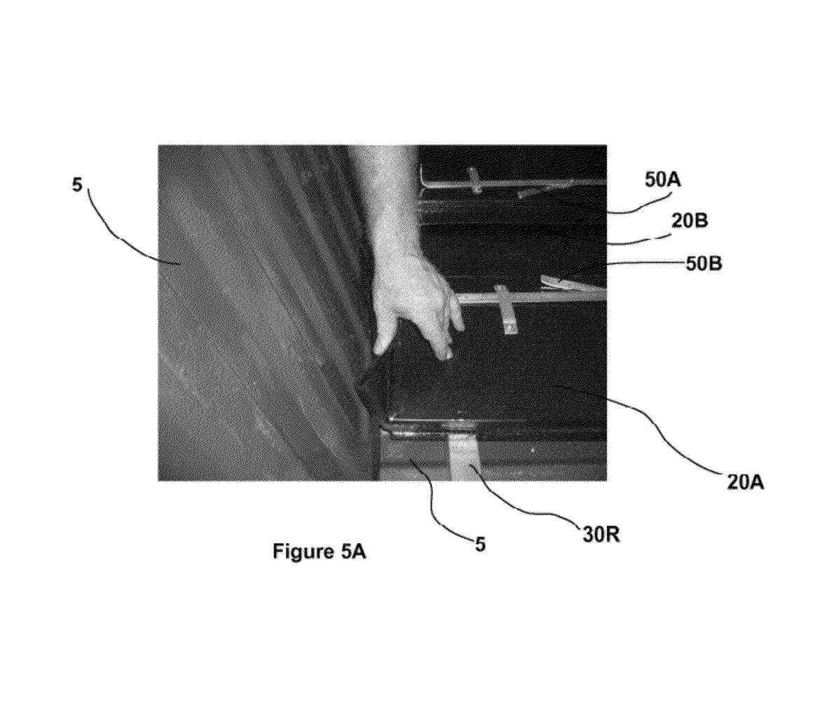

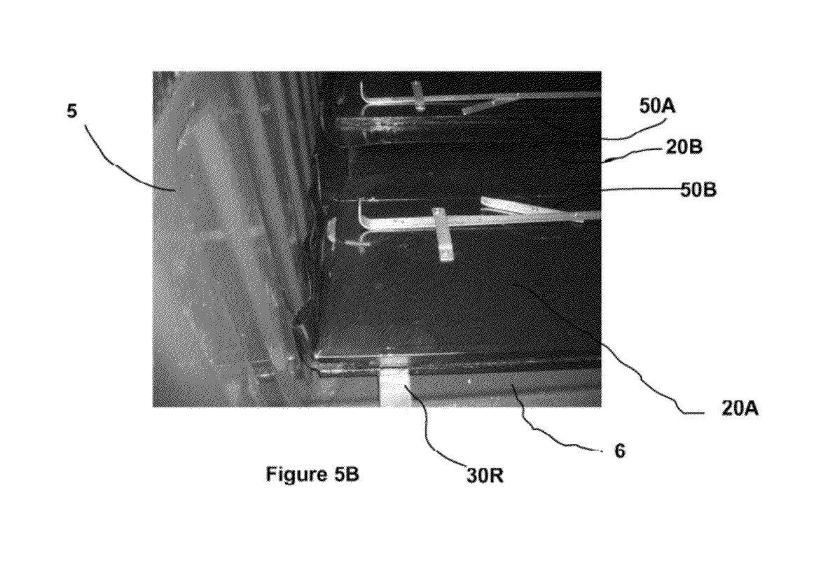

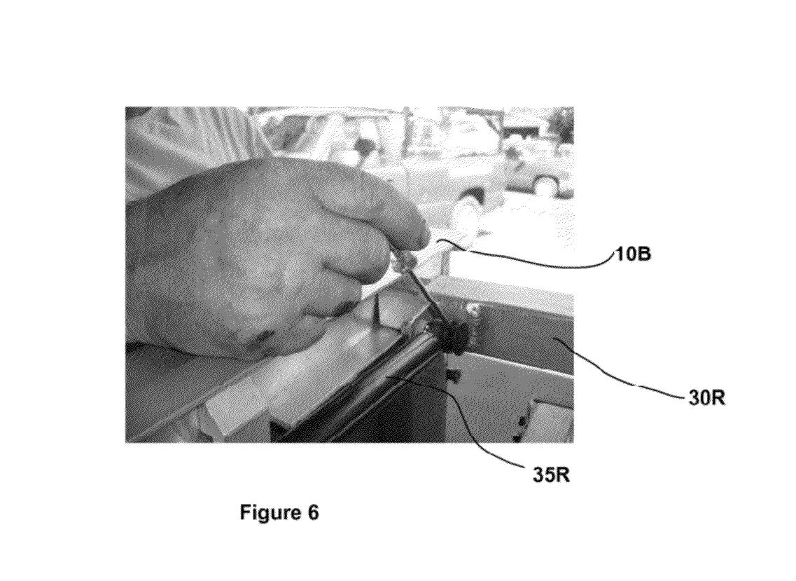

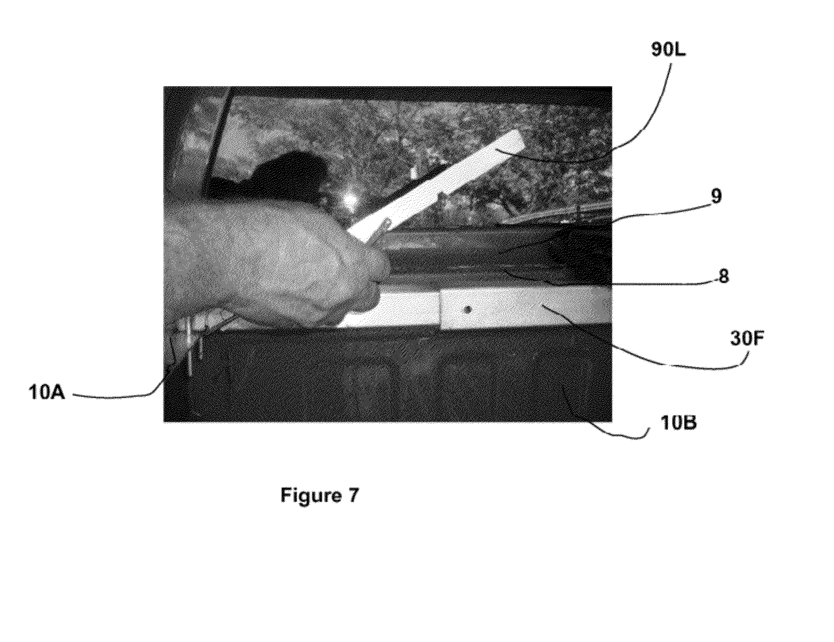

This model uses a C channel to carry 5 telescoping struts which support a wood or composite deck.
1. Normally without load on top, this model would use only 3 of the five struts. One secured to cargo deck front (strut #1) one secured to rear, (strut #5) and one unsecured strut between (strut #3).
2. With strut number 1, 3, 5, installed add strut #4 telescoped out to C channel and insert pin. FIG. 3
3. With door locking linkage pulled rearward open doors and rest them on main deck panel. FIG. 2
4. Push lock linkage forward. FIG. 2
5. Remove deck lift assist gas strut from strut #5.
6. Remove both pins from strut #1.
7. Retract strut #1 on both ends and position door props vertically. FIG. 7.
8. Loosen strut adjuster on strut 5 and retract strut on both ends. FIG. 3.
9. Slide cargo deck off of struts to tailgate. FIG. 4.
10. Set cargo deck on floor of truck and slide it forward until it meets the front wall of truck bed. FIG. 1.
11. On remaining struts #3, and 4, remove pins, retract struts and remove from c channel.
12. Bend flexible gasket along tailgate end of cargo deck. FIG. 5A.
13. With gasket bent up, close tailgate. FIG. 5B.

Reverse steps to reinstall the MuleBack Deluxe model configurable load carrying truck cover.

To install cargo deck in a lower position: Remove deck as above, insert struts in truck box pockets as provided by truck manufacture, telescope out and pin in place. Place cargo deck on struts 2, 3, 4 and Insert legs on both ends of struts 1 and 5. Deck is now lowered at an approximant elevation of top of wheel wells.

I claim:

1. A load carrying truck bed tonneau cover kit of cooperating components for installation on and within a truck bed body box of a pick-up truck having side rails, a forward cab rail, and a tail gate surrounding a bed thereof and forming the truck bed body box, the load carrying truck bed tonneau cover kit comprising:
a first C-channel like members and a plurality of clamps for being mountable to a second internal opposing side of the truck bed body box;
a second C-channel like member and a plurality of clamps for being mountable to a second internal opposing side of the truck bed body box;
a first pair of struts spanning the width of the truck bed body box, for engagement with the opposing C-channel like members;
a cargo deck including, a first substrate with longitudinal door substrates hingeably secured to the sides of the first substrate, and said cargo decks including surrounding gaskets for engagement with upper portions of the truck body box side walls that forms the truck bed, the forward portion of the truck body side walls in proximity to the truck cab, and the tail gate;
a slideably engageable cam assembly mounted to each longitudinal door substrates for subsequent engagement with each side C-channel;
a forward strut for engagement with the C-channel at the forward end of the truck bed box that is preferably mounted to the truck facing surface of the first substrate of the cargo deck;
a rearward strut for engagement with the C-channel at the rearward end of the truck bed that may be mounted to the truck facing surface of the first substrate; and
a plurality of cotter-less pins, clevis pins, or the like for quick assembly and removal of the tonneau cover with a minimum of any tools.

2. The load carrying truck bed tonneau cover kit of claim 1 wherein each of the struts include at least a pair of telescoping members.
